(19) United States
(12) Patent Application Publication
(10) Pub. No.: US 2015/0170592 A1
(43) Pub. Date: Jun. 18, 2015

(54) DISPLAY DEVICES WITH ENHANCED DRIVING CAPABILITY AND REDUCED CIRCUIT AREA OF DRIVING CIRCUIT

(71) Applicant: InnoLux Corporation, Miao-Li County (TW)

(72) Inventors: Jia-Hao BAI, Miao-Li County (TW); Jen-Chieh CHANG, Miao-Li County (TW)

(21) Appl. No.: 14/539,078

(22) Filed: Nov. 12, 2014

(30) Foreign Application Priority Data
Dec. 17, 2013 (TW) 102146543

(51) Int. Cl. G09G 3/36

(52) U.S. Cl. CPC G09G 3/3648; G09G 2300/0408; G09G 2310/0286; G09G 2320/0219

(57) ABSTRACT

A display panel includes a scan driving circuit. The scan driving circuit includes multiple shift-registers coupled in serial. At least one of the shift-registers includes a control circuit, a pumping circuit and an output circuit. The control circuit controls a voltage at a first control node according to a start-up signal and controls a voltage at a second control node according to a reset signal. The pumping circuit is coupled to the control circuit for pumping up the voltage at the first control node. The output circuit is coupled to the pumping circuit and the control circuit for outputting multiple gate driving signals at multiple output nodes in response to the voltage at the first control node. One of the output gate driving signals is provided to a following stage of shift-register as the start-up signal thereof.

### CROSS REFERENCE TO RELATED APPLICATIONS

This Application claims priority of Taiwan Patent Application No. 102146543, filed on Dec. 17, 2013, the entirety of which is incorporated by reference herein.

### BACKGROUND OF THE INVENTION

1. Field of the Invention

The invention relates to a display panel and a display device, and more particularly to a display panel and a display device with enhanced driving capability and reduced circuit area of driving circuit.

2. Description of the Related Art

Shift registers have been widely used in data driving circuits and gate driving circuit of the display devices, for controlling timing when receiving a data signal in each data line and for generating a scanning signal for each gate line. In the scan driving circuit, a shift register outputs a scanning signal to each gate line, so as to drive the pixels in each gate line. On the other hand, in a data driving circuit, a shift register outputs a selection signal to each data line, so as to write the image data into each data line.

When the resolution of display devices increase, the number of pixels and the corresponding control circuits increase. However, to avoid the overall circuit area of the driving circuits of the display device being greatly increased, the control circuits should be simplified while maintaining sufficient driving capability. Therefore, a novel driving circuit with not only enhanced driving capability but also reduced circuit area is needed.

### BRIEF SUMMARY OF THE INVENTION

Display panels are provided. An exemplary embodiment of a display panel comprises a scan driving circuit. The scan driving circuit comprises a plurality of shift-registers coupled in serial. At least one of the shift-registers comprises a control circuit, a pumping circuit and an output circuit. The control circuit controls a voltage at a first control node according to a start-up signal and controls a voltage at a second control node according to a reset signal. The pumping circuit is coupled to the control circuit for pumping up the voltage at the first control node. The output circuit is coupled to the pumping circuit and the control circuit for outputting multiple gate driving signals at multiple output nodes in response to the voltage at the first control node. One of the output gate driving signals is provided to a following stage of shift-register as the start-up signal thereof

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a display device according to an embodiment of the invention;

FIG. 2 shows a block diagram of an exemplary shift register;

FIG. 3 is a block diagram showing a plurality of shift registers coupled in serial according to an embodiment of the invention;

FIG. 4 shows a block diagram of a one-to-many shift register according to an embodiment of the invention;

FIG. 5 shows a circuit diagram of a one-to-many shift register according to an embodiment of the invention;

FIG. 6 is a diagram showing the voltage waveform at each node and the signal waveforms according to an embodiment of the invention;

FIG. 7 shows a block diagram of the shift register circuit according to another embodiment of the invention;

FIG. 8 shows a circuit diagram of a one-to-many shift register according to another embodiment of the invention; and

FIG. 9 is a diagram showing the voltage waveform at each node and the signal waveforms according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

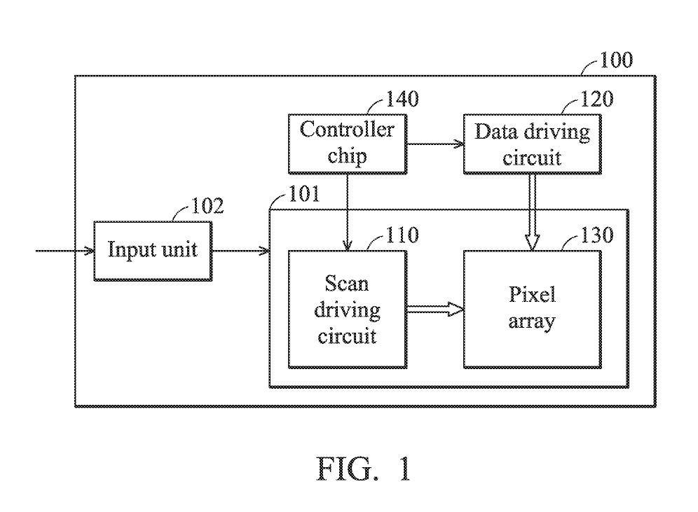

FIG. 1 is a block diagram of a display device according to an embodiment of the invention. As shown in FIG. 1, the display device 100 may comprise a display panel 101, a data driving circuit 120 and a controller chip 140. The display panel 101 may comprise a scan driving circuit 110 and a pixel array 130. The scan driving circuit 110 generates a plurality of gate driving signals to drive a plurality of pixels in the pixel array 130. The data driving circuit 120 generates a plurality of data driving signals to provide image data to the pixels of the pixel array 130. The controller chip 140 generates a plurality of timing signals, comprising clock signals, reset signals and start pulses.

In addition, the display device 100 may further comprise an input unit 102. The input unit 102 receives image signals and controls the display panel 101 to display images. According to an embodiment of the invention, the display device 100 may further be comprised in an electronic device. The electronic device may be implemented as various devices, comprising: a mobile phone, a digital camera, a personal digital assistant (PDA), a lap-top computer, a personal computer, a television, an in-vehicle display, a portable DVD player, or any apparatus with image display functionality.

According to an embodiment of the invention, the scan driving circuit 110 may comprise a plurality of shift registers coupled in serial, and the shift registers may generate a corresponding gate driving signal to each gate line in sequence, so as to drive the pixels in each gate line.

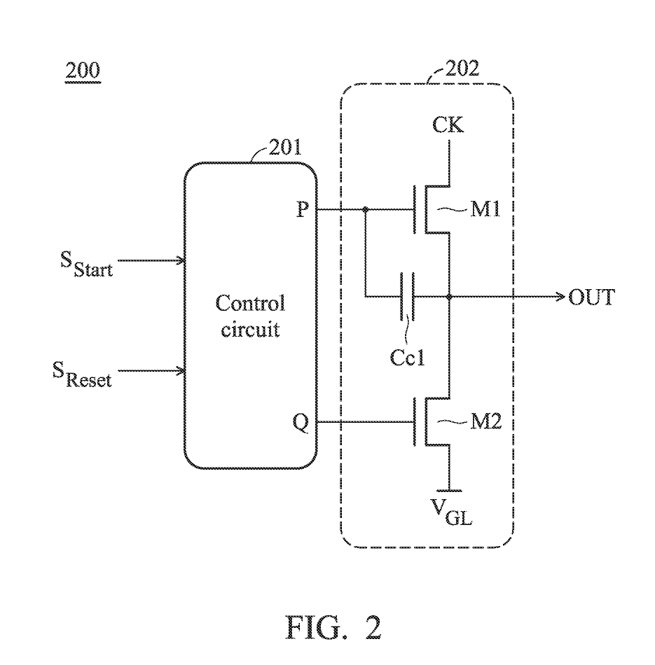

FIG. 2 shows a block diagram of an exemplary shift register. The shift register 200 may comprise a control circuit 201 and an output circuit 202. The control circuit 201 may control voltages at the control nodes P and Q according to the start-up signal S_{Start} and the reset signal S_{Reset}. The output circuit 202 may comprise transistors M1 and M2 and a capacitor Cc1. The transistor M1 is coupled to the control node P and is turned on or off in response to the voltage at the control node P. The transistor M2 is coupled to the control node Q and is turned on or off in response to the voltage at the control node Q. When the transistor M1 is turned on, the clock signal CK is transmitted to the output node OUT as the output gate driving signal. When the transistor M2 is turned on, the voltage at the output node OUT is reset as the low operation voltage V_{GL}. Since the gate driving signal is usually transmitted to a following stage of shift register as the start-up signal of the following stage of shift register, the output circuit 202 usually comprises a capacitor Cc1 for pumping up the voltage at the control node P, so as to enhance the driving capability of the gate driving signal. Thereby, the voltage of the gate driving signal is sufficient to start-up the following stage of shift register.

The shift register 200 shown in FIG. 2 is a one-to-one shift register, wherein the shift register 200 only outputs one gate driving signal. However, in order to further simplify the circuit area of the scan driving circuit, the shift register is evolved into a one-to-many structure. In other words, one stage of shift register may output multiple gate driving signals for driving multiple gate lines.

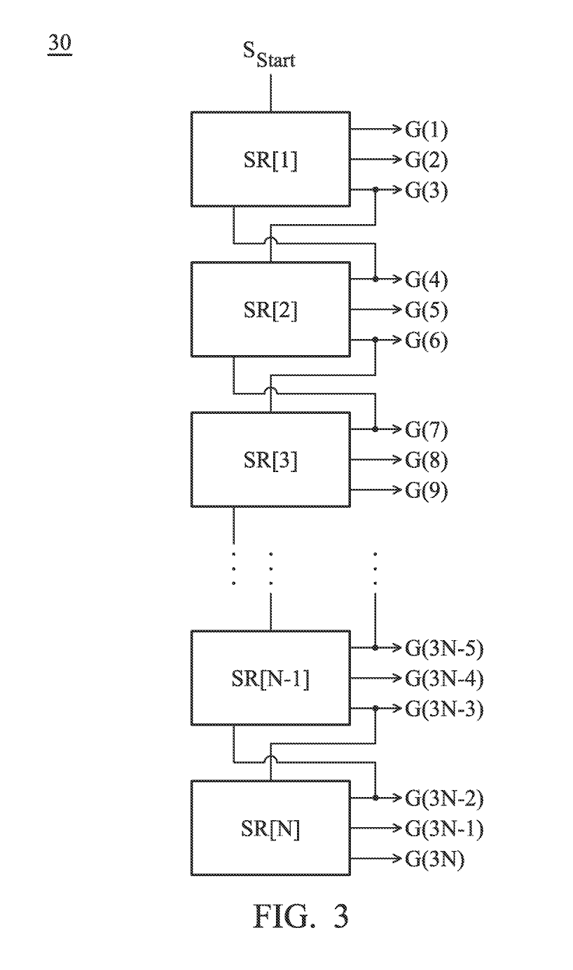

FIG. 3 is a block diagram showing a plurality of shift registers coupled in serial according to an embodiment of the invention. The scan driving circuit 30 may comprise a plurality of one-to-many shift registers SR[1], SR[2], SR[3], . . . SR[N−1] and SR[N] coupled in serial, where N is a positive integer. Note that in order to clarify the concept of the invention, the shift registers SR[1]-SR[N] shown in FIG. 3 are one-to-three shift registers. However, it is understood that for those who are skilled in this technology can still make various alterations and modifications without departing from the scope and spirit of this invention to implement the one-to-two, one-to-four, or other types of one-to-many shift registers. Therefore, the invention should not be limited to the structure as shown in FIG. 3.

As shown in FIG. 3, each shift register SR[1]-SR[N] outputs three gate driving signals. For example, the shift register SR[1] outputs gate driving signals G(1)-G(3), the shift register SR[2] outputs gate driving signals G(4)-G(6), and so on. Besides the first stage of shift register SR[1], each shift register may receive one of the multiple gate driving signals output by a previous stage of shift register as the start-up signal. The first stage of shift register SR[1] may receive the start pulse from the controller chip as the corresponding start-up signal S_{Start} thereof. In addition, besides the last stage of shift register SR[N], each shift register may receive one of the multiple gate driving signals output by a following stage of shift register as the reset signal (not shown in FIG. 3). The last stage of shift register SR[N] may receive the system reset signal from the controller chip as the corresponding reset signal thereof

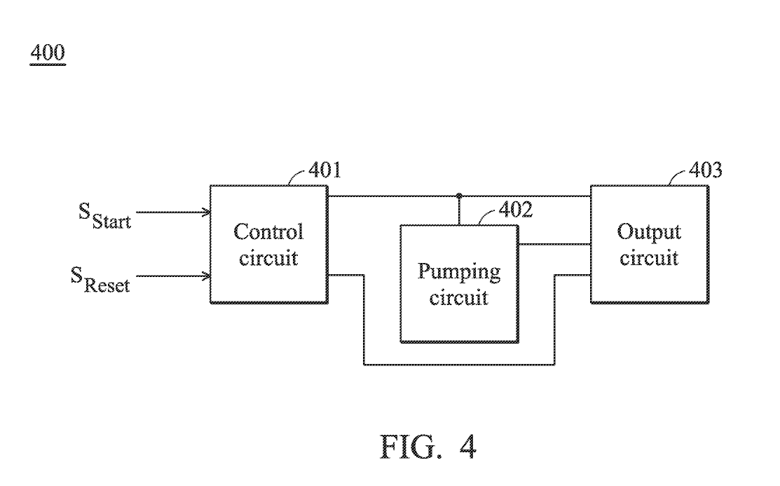

FIG. 4 shows a block diagram of a one-to-many shift register according to an embodiment of the invention. The shift register 400 may comprise a control circuit 401, a pumping circuit 402 and an output circuit 403. The control circuit 401 may control a voltage at the control node P according to the start-up signal S_{Start}, and control a voltage at the control node Q according to the reset signal S_{Reset}. As discussed above, the start-up signal S_{Start} may be the start pulse or one of a plurality of gate driving signals output by a previous stage of shift register. The reset signal S_{Reset} may be the system reset signal or one of a plurality of gate driving signals output by a following stage of shift register.

The pumping circuit 402 is coupled to the control circuit 401 for pumping up the voltage at the control node P. The output circuit 403 is coupled to the pumping circuit 402 and the control circuit 401, and outputs a plurality of gate driving signals at a plurality of output nodes in response to the voltages at the control nodes P and Q. According to an embodiment of the invention, the control circuit 401 may pull up the voltage at the control node P to a first high voltage level within a first time interval, and the pumping circuit 402 may further pumping up the voltage at the control node P to a second high voltage level higher than the first high voltage level within a second time interval. The one-to-many shift register will be discussed further in more detail in the following paragraphs.

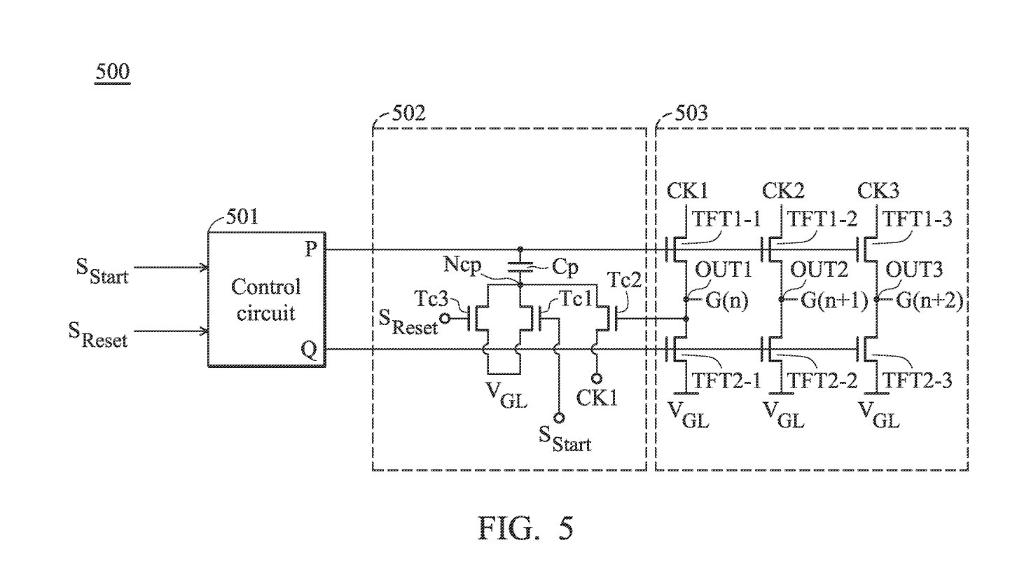

FIG. 5 shows a circuit diagram of a one-to-many shift register according to an embodiment of the invention. The shift register 500 may comprise a control circuit 501, a pumping circuit 502 and an output circuit 503. The control circuit 501 may control a voltage at the control node P according to the start-up signal S_{Start}, and control a voltage at the control node Q according to the reset signal S_{Reset}. The output circuit 503 may comprise a plurality of output units, and each output unit may respectively comprise a pair of transistors coupled in serial, such as the transistors TFT1-1 and TFT2-1, TFT1-2 and TFT2-2, and TFT1-3 and TFT2-3. Each output unit may respectively receive different clock signal as the corresponding input signal, and may output the corresponding gate driving signals G(n), G(n+1) and G(n+2) at the corresponding output nodes OUT1, OUT2 and OUT3, where n is a positive integer.

According to an embodiment of the invention, the transistor TFT1-1 may comprise a first terminal coupled to an input node for receiving the clock signal CK1, a second terminal coupled to the control node P and a third terminal coupled to the output node OUT1. The transistor TFT2-1 may comprise a first terminal coupled to the output node OUT1, a second terminal coupled to the control node Q and a third terminal coupled to the low operation voltage V_{GL}. Similarly, the transistor TFT 1-2 may comprise a first terminal coupled to an input node for receiving the clock signal CK2, a second terminal coupled to the control node P and a third terminal coupled to the output node OUT2. The transistor TFT2-2 may comprise a first terminal coupled to the output node OUT2, a second terminal coupled to the control node Q and a third terminal coupled to the low operation voltage V_{GL}. The transistor TFT1-3 may comprise a first terminal coupled to an input node for receiving the clock signal CK3, a second terminal coupled to the control node P and a third terminal coupled to the output node OUT3. The transistor TFT2-3 may comprise a first terminal coupled to the output node OUT3, a second terminal coupled to the control node Q and a third terminal coupled to the low operation voltage V_{GL}.

The pumping circuit 502 may comprise a capacitor Cp and a plurality of pumping elements. The capacitor Cp is cross coupled between the control nodes P and Ncp. The first pumping element is coupled to the control node Ncp for receiving the start-up signal S_{Start} and controls the voltage at the control node Ncp in response to the start-up signal S_{Start}. The second pumping element is coupled between the control node Ncp and one of the output nodes OUT1˜OUT3 for receiving one of the gate driving signals G(n)˜G(n+2) and further pumps up the voltage at the control node Ncp in response to the received gate driving signal.

According to an embodiment of the invention, the pumping element may be a transistor, such as the transistors Tc1 and Tc2. The transistor Tc1 may comprise a first terminal coupled to the control node Ncp, a second terminal receiving the start-up signal S_{Start}, and a third terminal coupled to the low operation voltage V_{GL}. The transistor Tc2 may comprise a first terminal coupled to the control node Ncp, a second terminal coupled to the output node OUT1 and a third terminal coupled to the input node for receiving the clock signal CK1. According to an embodiment of the invention, the pumping circuit 502 may further comprise a transistor Tc3. The transistor Tc3 may comprise a first terminal coupled to the control node Ncp, a second terminal receiving the reset signal S_{Reset} and a third terminal coupled to the low operation voltage V_{GL} for resetting the voltage at the control node Ncp in response to the reset signal S_{Reset}.

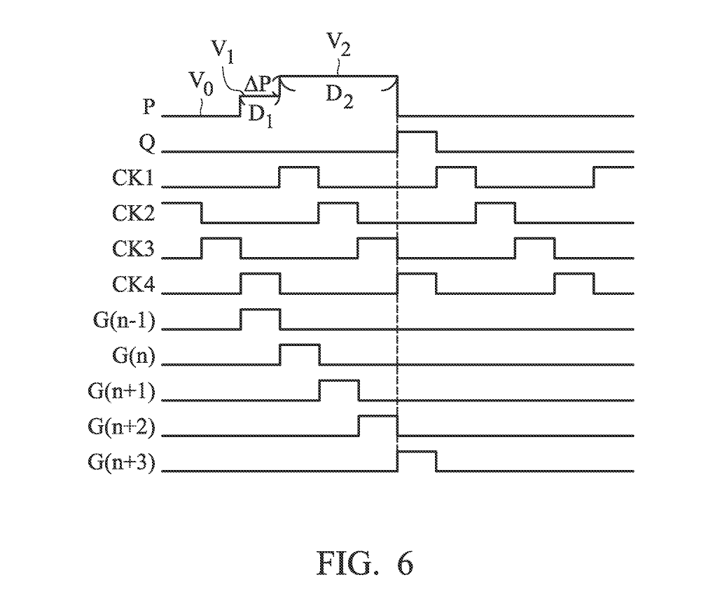

FIG. 6 is a diagram showing the voltage waveform at each node and the signal waveforms according to the embodiments of the invention. According to an embodiment of the invention, the start-up signal S_{Start} may be the gate driving signal G(n−1) output by a previous stage of shift register, and the reset signal S_{Reset} may be the gate driving signal G(n+3) output by a following stage of shift register. Accompanying the circuit diagram in FIG. 5 with the waveform in FIG. 6, operations of the one-to-many shift register will be discussed further in more detail in the following paragraphs.

Suppose that the initial voltage at the control node P is V₀, where the voltage V₀ may have a low voltage level, such as a low voltage level of the low operation voltage V_{GL}. When a pulse of the start-up signal S_{Start} arrives, the voltage at the control node P is pumped up to a high voltage level V₁ under the control of the control circuit 501. At this time, the transistor Tc1 is turned on such that the control node Ncp has a low voltage level like that of the low operation voltage V_{GL}. Meanwhile, the transistors TFT1-1, TFT1-2 and TFT1-3 are turned on for respectively outputting the clock signals CK1, CK2 and CK3 as the corresponding gate driving signals G(n), G(n+1) and G(n+2).

When a pulse of the clock signal CK1 arrives, the gate driving signal G(n) generates a pulse accordingly. At this time, the transistor Tc2 is turned on, thus pulling high the voltage at the control node Ncp to a high voltage level approximate to the high operation voltage V_{GH}. Meanwhile, the voltage at the control node P is pulled high to another high voltage level V₂ in response to the change in the voltage at the control node Ncp. As shown in FIG. 6, the control node P has a high voltage level V₁ within the first time interval D1, and has a high voltage level V₂ within the second time interval D2, where V₂>V₁. Finally, when a pulse of the reset signal S_{Reset} arrives, the voltage at the control node P is reset. At the same time, the voltage at the control node Q has a high voltage level for resetting the voltage level at the output nodes OUT1-OUT3.

According to an embodiment of the invention, since the voltage at the control node Ncp is first charged to the low voltage level in response to the pulse of the start-up signal S_{Start}, and then charged to the high voltage level in response to the clock signal CK1 and the gate driving signal G(n). Therefore, due to the coupling effect of the capacitor Cp, the voltage change at the control node Ncp is coupled to the control node P, such that the voltage at the control node P is pumping up from the voltage V₁ to the voltage V₂ for enhancing the driving capability of the shift register. When the electronic elements in the circuit are adequately designed, the difference A P between the voltages V₂ and V₁ is about (V_{GH}-V_{GL}).

Compared to the circuit as shown in FIG. 2, in a preferred embodiment of the invention, the capacitor in the output circuit is removed and the pumping circuit 502 is utilized for pumping up the voltage at the control node P instead. Therefore, the voltage difference ΔP of the control node P does not fade due to the capacitance dispersion effect. Note that if the capacitor in the output circuit is not removed, when the number of output units coupled to the output circuit increases, the capacitance dispersion effect increases. In this manner, the voltage at the control node P will suffer more serious fading.

In the preferred embodiment of the invention, as shown in FIG. 6, the voltage at the control node P is pumped up to a voltage level that is much higher than the high operation voltage V_{GH} of the system within the second time interval D2. In this manner, the driving capability of the control node P is enhanced, such that the pulse of the clock signal received at each input node can be completely transmitted to the corresponding output node as the gate pulse. Note that in the proposed circuit structure, even if the number of output units coupled to the output circuit increases, the voltage at the control node does not seriously fade. Therefore, the problem of insufficient driving capability of the conventional one-to-many shift register is solved.

In addition, as discussed above, since the gate driving signal output by a shift register is provided to a following stage of shift register as the start-up signal thereof, besides enhancing the voltage pumping capability at the control node P within the second time interval D2, according to another embodiment of the invention, the control circuit 401/501 may further receive a pre-charge signal and control the voltage at the control node P within the first time interval D1 according to the pre-charge signal and the start-up signal. Thereby, the driving capability of the start-up signal within the first time interval D1 is further enhanced.

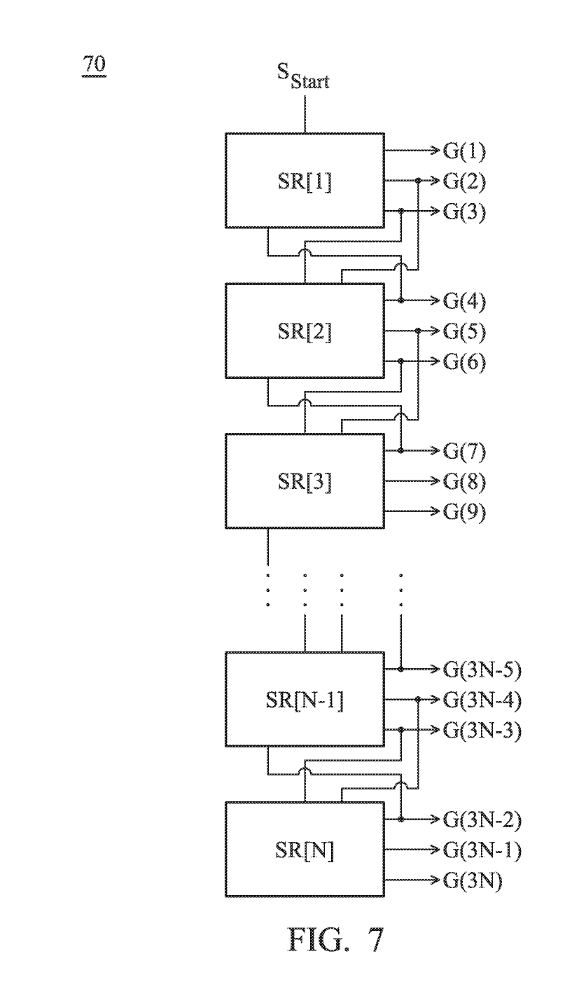

According to an embodiment of the invention, the pre-charge signal may be one of a plurality of gate driving signals output by a previous stage of shift register, and it is preferable for the pulse of the pre-charge signal to arrive earlier than the pulse of the start-up signal. FIG. 7 shows a block diagram of the shift register circuit according to another embodiment of the invention. The shift register circuit 70 may comprise a plurality of one-to-many shift registers SR[1], SR[2], SR[3], . . . SR[N−1] and SR[N] coupled in serial, where N is a positive integer. Note that in order to clarify the concept of the invention, the shift registers SR[1]-SR[N] shown in FIG. 7 are one-to-three shift registers. However, it is understood that those who are skilled in this technology can still make various alterations and modifications without departing from the scope and spirit of this invention to implement the one-to-two, one-to-four, or other types of one-to-many shift registers. Therefore, the invention should not be limited to the structure as shown in FIG. 7.

The structure of the circuit shown in FIG. 7 is similar to that shown in FIG. 3, and the only difference is that, besides the first stage of shift register SR[1], each stage of shift register receives two of the multiple gate driving signals output by a previous stage of shift register as the stat-up signal and the pre-charge signal. The description of FIG. 7 may refer to that of FIG. 3, and are omitted here for brevity. The proposed control circuit will further be discussed in more detailed in the following paragraphs.

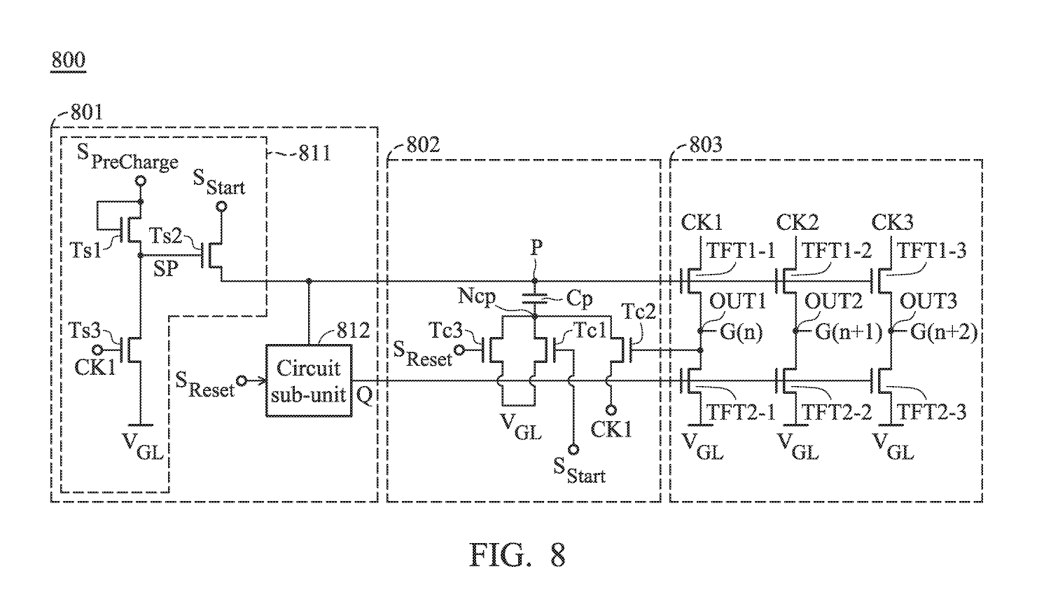

FIG. 8 shows a circuit diagram of a one-to-many shift register according to another embodiment of the invention. The shift register 800 may comprise a control circuit 801, a pumping circuit 802 and an output circuit 803. The circuit structures of the pumping circuit 802 and the output circuit 803 are similar to those of the pumping circuit 502 and the output circuit 503 shown in FIG. 5. Therefore, the corresponding description may refer to that of FIG. 5, and are omitted here for brevity. According to an embodiment of the invention, the control circuit 801 may comprise a plurality of circuit sub-units, such as the circuit sub-units 811 and 812. The circuit sub-unit 811 may control the voltage at the control node P according to the start-up signal S_{Start} and the pre-charge signal S_{PreCharge}. The circuit sub-unit 812 may control the voltage at the control node Q according to the reset signal S_{Reset}. Note that the control circuit may also comprise other circuit sub-units not shown in FIG. 8, and therefore, the invention should not be limited to the structure shown in FIG. 8.

The circuit sub-unit 811 may comprise a plurality of control elements. A first control element is coupled to the control node SP and receives the pre-charge signal S_{PreCharge} for controlling a voltage at the control node SP in response to the pre-charge signal S_{PreCharge}. A second control element is coupled to the control nodes P and SP, and it receives the start-up signal S_{Start} and pumps up the voltage at the control node SP in response to the start-up signal Sₛₜₐᵣₜ. A third control element is coupled to the control node SP and receives the input clock CK1 for controlling the voltage at the control node SP in response to the input signal CK1.

According to an embodiment of the invention, the control element may consist of transistors. For example, the transistors Ts1, Ts2 and Ts3. The transistor Ts1 may comprise a first terminal and a second terminal receiving the pre-charge signal S_{PreCharge} and a third terminal coupled to the control node SP. The transistor Ts2 may comprise a first terminal receiving the start-up signal, a second terminal coupled to the control node SP and a third terminal coupled to the control node P. The transistor Ts3 may comprise a first terminal coupled to the control node SP, a second terminal receiving an input signal CK1 and a third terminal coupled to the low operation voltage V_{GL}.

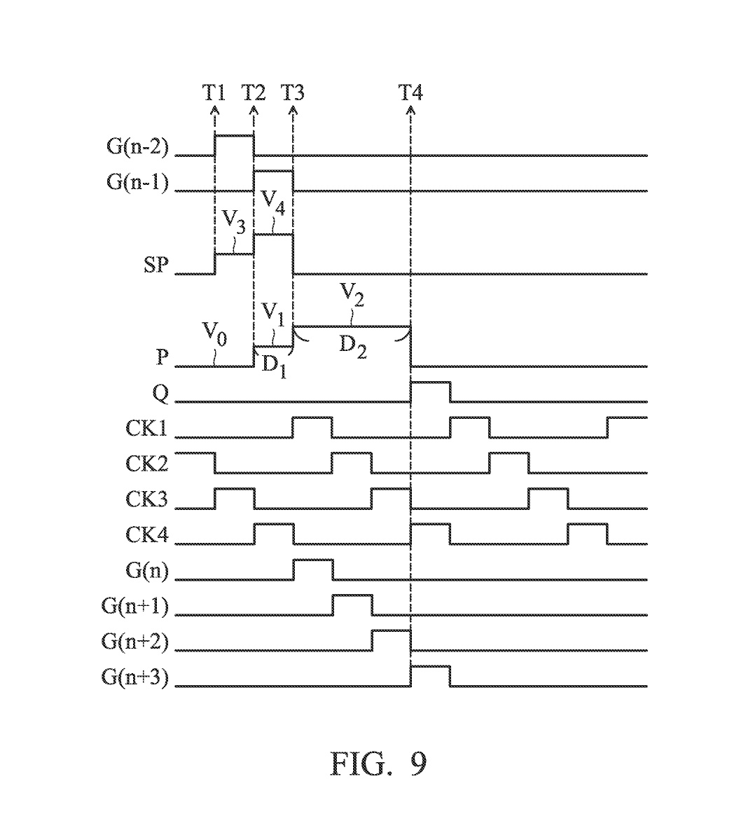

FIG. 9 is a diagram showing the voltage waveform at each node and the signal waveforms according to another embodiment of the invention. According to an embodiment of the invention, the start-up signal S_{Start} may be the gate driving signal G(n−1) output by a previous stage of shift register, the pre-charge signal S_{PreCharge} may be the gate driving signal G(n−2) output by the previous stage of shift register, and the reset signal S_{Reset} may be the gate driving signal G(n+3) output by a following stage of shift register. Accompanying the circuit diagram in FIG. 8 with the waveform in FIG. 9, operations of the one-to-many shift register will be further discussed in more detailed in the following paragraphs.

According to an embodiment of the invention, when a pulse of the pre-charge signal S_{PreCharge} arrives at time T1, the transistor Ts1 is turned on, such that the voltage at the control node SP has a third high voltage level V₃. At the same time, the transistor Ts2 is turned on in response to the high voltage level at the control node SP. When a pulse of the start-up signal S_{Start} arrives at time T2, the voltage at the control node P is pulled high to a first high voltage level V₁, such that the voltage at the control node SP is pulled high to a fourth high voltage level V₄ higher than the third high voltage level V₃ in response to the change (that is, from V₀ to V₁) in the voltage at the control node P.

In the embodiment of the invention, the control node SP is charged via the transistor Ts1 by using the pre-charge signal S_{PreCharge}, and the transistor Ts2 is turned on in advance. Therefore, the voltage at the control node SP is further pumped up when a pulse of the start-up signal S_{Start} arrives. In this manner, the control node SP can successfully charge up the control node P without a voltage drop and the driving capability of the control node P is enhanced within the first time interval D1.

When a pulse of the clock signal CK1 arrives at time T3, the voltage at the control node P is pulled high to another high voltage level V₂ in response to the voltage at the control node Ncp. As shown in FIG. 9, the control node P has a high voltage level V₁ within the first time interval D1, and has a high voltage level V₂ within the second time interval D2, where V₂>V₁. At the same time (T3), the transistor Ts3 is turned on for resetting the voltage at the control node SP, and the transistor Ts2 is turned off. Finally, when a pulse of the reset signal S_{Reset} arrives at the time T4, the voltage at the control node P is reset. At the same time (T4), the voltage at the control node Q has a high voltage level for resetting the voltage levels at the output nodes OUT1-OUT3.

In the preferred embodiments of the invention, the voltage level of the control node P is raised in a two-step manner within the first time interval D1 via the circuit sub-unit 811. The voltage level of the control node P is further pumped up within the second time interval D2 via the pumping circuit 402/502/802. In this manner, the driving capability of the control node P is enhanced, such that the pulses of the clock signals received at each input node are completely transmitted to the output nodes as the gate pulses, and the gate driving signals output by each shift register can be completely provided to a following stage of shift register as the start-up signal thereof. The problem of insufficient driving capability of the conventional one-to-many shift register is solved. In addition, via the design of multiple output units in one shift register, the circuit area of the shift register circuit is reduced such that the circuit area of the overall scan driving circuit is reduced.

Note that in order to clarify the concept of the invention, the shift registers illustrated above are one-to-three shift registers. However, it is understood that for those who are skilled in this technology can still make various alterations and modifications without departing from the scope and spirit of this invention to implement the one-to-two, one-to-four, or other types of one-to-many shift registers. Therefore, the invention should not be limited to the structures as shown in the figures. In addition, in the embodiments of the invention, for a one-to-K shift register, it is preferable to use (K+1) clock signals. For example, in the waveforms as shown in FIG. 6 and FIG. 9, the clock signals utilized by the 1-to-3 shift register are CK1-CK4. However, it should be noted that the configuration of the clock signals at each input terminal are merely one of a plurality of possible embodiments, and the invention should not be limited to the clock configurations as shown in the figures.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display panel, comprising:
a scan driving circuit, comprising a plurality of shift-registers coupled in serial,
wherein at least one of the shift-registers comprises:
a control circuit, controlling a voltage at a first control node according to a start-up signal and controlling a voltage at a second control node according to a reset signal;
a pumping circuit, coupled to the control circuit for pumping up the voltage at the first control node; and
an output circuit, coupled to the pumping circuit and the control circuit for outputting a plurality of gate driving signals at a plurality of output nodes in response to the voltage at the first control node,
wherein one of the gate driving signals is provided to a following stage of shift-register as the start-up signal thereof.

2. The display panel as claimed in claim 1, wherein the pumping circuit comprises:
a capacitor, coupled between the first control node and a third control node;
a first transistor, comprising a first terminal coupled to the third control node, a second terminal receiving the start-up signal and a third terminal coupled to a low operation voltage; and
a second transistor, comprising a first terminal coupled to the third control node, a second terminal coupled to one of the output nodes and a third terminal coupled to an input terminal for receiving an input signal.

3. The display panel as claimed in claim 2, wherein when a pulse of the start-up signal arrives, the voltage at the first control node has a first high voltage level and the first transistor is turned on for a voltage at the third control node to have a low voltage level.

4. The display panel as claimed in claim 3, wherein when a pulse of one of the gate driving signals arrives, the second transistor is turned on for pulling up the voltage at the third control node according to the input signal, and the voltage at the first control node is pulled high to a second high voltage level higher than the first high voltage level in response to the voltage at the third control node.

5. The display panel as claimed in claim 2, wherein the pumping circuit further comprises:
a third transistor, comprising a first terminal coupled to the third control node a second terminal receiving the reset signal and a third terminal coupled to the low operation voltage, for resetting the voltage at the third control node in response to the reset signal.

6. The display panel as claimed in claim 1, wherein the control circuit further receive a pre-charge signal and controls the voltage at the first control node according to the pre-charge signal and the start-up signal, wherein the pre-charge signal is one of the gate driving signals output by a previous stage of shift-register, and wherein a pulse of the pre-charge signal arrives earlier than a pulse of the start-up signal.

7. The display panel as claimed in claim 6, wherein the control circuit comprises:
a fourth transistor, comprising a first terminal and a second terminal receiving the pre-charge signal and a third terminal coupled to a fourth control node; and
a fifth transistor, comprising a first terminal receiving the start-up signal, a second terminal coupled to the fourth control node and a third terminal coupled to the first control node.

8. The display panel as claimed in claim 7, wherein when a pulse of the pre-charge signal arrives, the fourth transistor is turned on such that a voltage at the fourth control node has a third high voltage level and the fifth transistor is turned on.

9. The display panel as claimed in claim 8, wherein when a pulse of the start-up signal arrives, the voltage at the first control node is pulled high and the voltage at the fourth control node is pulled high to a fourth high voltage level higher than the third high voltage level in response to the voltage at the first control node.

10. The display panel as claimed in claim 7, wherein the control circuit comprises:
a sixth transistor, comprising a first terminal coupled to the fourth control node, a second terminal receiving the input signal and a third terminal coupled to the low operation voltage for resetting the voltage at the fourth control node in response to the input signal.
